(19) United States
(12) Patent Application Publication
(10) Pub. No.: US 2012/0106635 A1
(43) Pub. Date: May 3, 2012

(54) ENCODER, ENCODING METHOD, AND PROGRAM

(76) Inventor: Daisuke Tsuru, Chiba (JP)

(21) Appl. No.: 13/267,120

(22) Filed: Oct. 6, 2011

(30) Foreign Application Priority Data
Oct. 15, 2010 (JP) 2010-232559

(51) Int. Cl. H04N 7/32

(52) U.S. Cl. 375/240.12; 375/E07.243

(57) ABSTRACT

An encoder including a code amount prediction unit predicting the amount of code of data to be encoded, the code amount prediction unit including a conversion unit converting input syntax elements to symbol data, and a measurement unit measuring the predicted amount of code of the data to be encoded on the basis of the number of times of renormalization processing performed on each bit in an arithmetic encoding process applied to the symbol data.

### BACKGROUND

The present disclosure relates to an encoder, encoding method, and program, and more particularly to an encoder, encoding method, and program allowing for fast prediction of the amount of code.

In recent years, video codecs for business or broadcasting use include AVC-Intra codecs (see http://ja.wikipedia.org/wiki/AVC-Intra, for example). AVC-Intra codecs include AVC-Intra 100 for full high definition and AVC-Intra 50 for news broadcasting. Images compressed (encoded) by AVC-Intra codecs typically have the following features:

Complying with H.264 and MPEG-4 Part 10 Advanced Video Coding (H.264/AVC);

Constructed only by intraframe compression; and

All the compressed frames having the same code amount.

In addition, AVC-Intra 100 corresponds to the 10-bit 4:2:2 sampling format, while AVC-Intra 50 corresponds to the 10-bit 4:2:0 sampling format.

In encoders employing such AVC-Intra codecs, if the net amount of code in a compressed frame does not reach a defined amount, dummy data is inserted to such a frame using a predetermined technique to keep the amount of code identical between the compressed frames. Since the image quality does not rely on this dummy data, the amount of inserted dummy data is preferably minimized to obtain a higher quality image.

To minimize the amount of dummy data to be inserted, it is necessary to identify the optimum encoding parameter within the defined amount by performing an encoding process mainly with a plurality of encoding parameters of which the quantization values become dominant.

In real-time encoding or other use cases for which the processing time length is important, the following two techniques are considered for identifying the encoding parameters:

(1) Prepare the same number of encoders as the total number of encoding parameters and run these encoders in parallel, to identify an optimum encoding parameter from the obtained encoding results; and

(2) Identify an optimum encoding parameter through a predetermined number of times of encoding (in multiple passes).

With the technique (1) above, a truly optimum solution can be obtained as the encoding parameter, but it is necessary to prepare a large number of encoders and results in an increased mounting cost. On the other hand, with the technique (2), a truly optimum solution may not be reached, but it is necessary to prepare at least one encoder and results in a reduced mounting cost.

When the technique (2) above is used, it is necessary to ensure accuracy in determining the amount of code generated in one encoding process (referred to hereinafter as code amount prediction). The amount of code actually generated by an encoding scheme such as CABAC (context-based adaptive binary arithmetic coding) or CAVLC (context-based adaptive variable length coding) in H.264/AVC may be used as the most accurate amount of code to be obtained.

### SUMMARY

In the code amount prediction techniques described above, it is necessary to perform, in addition to the process necessary for calculating the amount of code (number of bits), other processes for writing streams for storage, calculation for determining the output bits in CABAC, etc., which are redundant and decrease the code amount prediction speed.

It is desirable to enable fast prediction of the amount of code.

An encoder according to an embodiment of the present disclosure includes a code amount prediction unit predicting the amount of code of data to be encoded. This code amount prediction unit includes a conversion unit converting input syntax elements to symbol data and a measurement unit measuring the predicted amount of code of the data to be encoded, on the basis of the number of times of renormalization processing performed on each bit in an arithmetic encoding process applied to the symbol data.

The code amount prediction unit can measure the predicted amount of code of the data to be encoded without inserting an EPB (emulation prevention byte) into the encoded data output by the arithmetic encoding process applied to the symbol data.

The code amount prediction unit can measure the predicted amount of code of the data to be encoded without accumulating the encoded data output by the arithmetic encoding process applied to the symbol data.

CABAC (context-based adaptive binary arithmetic coding) can be used for the arithmetic encoding process.

At least any one of the CABAC functions EncodeDecision, EncodeBypass, and EncodeTerminate can be used for the arithmetic encoding process.

An encoding method according to an embodiment of the present disclosure is a code amount prediction method of encoders having a code amount prediction unit predicting the amount of code of the data to be encoded. This method includes measuring the predicted amount of code of the data to be encoded, on the basis of the number of times of renormalization processing performed on each bit in the arithmetic encoding process applied to the symbol data converted from input syntax elements.

A program according to an embodiment of the present disclosure causes a computer to execute a code amount prediction process predicting the amount of code of the data to be encoded. This process includes measuring the predicted amount of code of the data to be encoded, on the basis of the number of times of renormalization processing performed on each bit in the arithmetic encoding process applied to the symbol data converted from input syntax elements.

In an embodiment of the present disclosure, input syntax elements are converted to symbol data and the predicted amount of code of the data to be encoded is measured on the basis of the number of times of renormalization processing performed on each bit in the arithmetic encoding process applied to the symbol data.

In an embodiment of the present disclosure, the code amount prediction speed can be increased.

### BRIEF DESCRIPTION OF THE DRAWINGS

FIG. 1 is a block diagram showing the structure of an encoder according to an embodiment of the present disclosure;

FIG. 2 is a block diagram showing the structure of an encoding unit;

FIG. 3 illustrates the insertion of an EPB (emulation prevention byte);

FIG. 4 illustrates an arithmetic encoding process;

FIG. 5 is a flowchart illustrating a renormalization process in a typical encoding process;

FIG. 6 is a block diagram showing the structure of a code amount prediction unit;

FIG. 7 is a flowchart illustrating an encoding process;

FIG. 8 is a flowchart illustrating a code amount prediction process;

FIG. 9 is a flowchart illustrating a code amount prediction process;

FIG. 10 is a flowchart illustrating a code amount prediction process;

FIG. 11 is a flowchart illustrating a code amount prediction process;

FIG. 12 is a flowchart illustrating a code amount prediction process;

FIG. 13 is a block diagram showing the structure of a decoder;

FIG. 14 is a flowchart illustrating a decoding process; and

FIG. 15 is a block diagram showing an exemplary hardware structure of a computer.

### DETAILED DESCRIPTION OF EMBODIMENTS

Embodiments of the present disclosure will now be described with reference to the drawings.

### [Structure of Encoder]

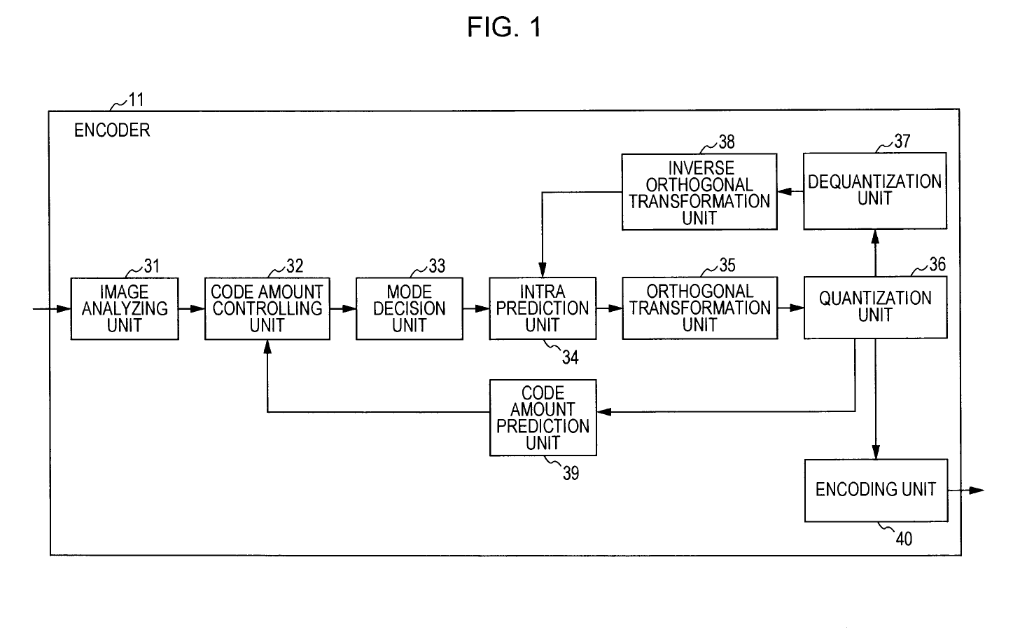

FIG. 1 shows the functional structure of an encoder according to an embodiment of the present disclosure.

In FIG. 1, an encoder 11 is an AVC-Intra-based encoder and performs encoding in the so-called 2-pass encoding scheme according to the H.264 and MPEG-4 Part 10 Advanced Video Coding (H.264/AVC) standards. First, the encoder 11 encodes an input image once in a fixed quantization step (first pass of encoding process) and determines the target amount of code to be generated in a real encoding process on the basis of the data, such as the amount of code, generated in the first pass. Next, the encoder 11 actually encodes the input image in the quantization step in which the target amount of code is generated (second pass of encoding process).

The encoder 11 includes an image analyzing unit 31, code amount controlling unit 32, mode decision unit 33, intra prediction unit 34, orthogonal transformation unit 35, quantization unit 36, dequantization unit 37, inverse orthogonal transformation unit 38, code amount prediction unit 39, and encoding unit 40.

The image analyzing unit 31 converts each of the sequentially input frame images of an image into image data including luminance signals and corresponding chrominance signals and supplies this image data to the code amount controlling unit 32.

For each image data supplied from the image analyzing unit 31, the code amount controlling unit 32 sets as the target amount of code (quantization value) the amount of code that becomes optimum when the image data is encoded in the predetermined quantization step. The code amount controlling unit 32 also resets the target amount of code on the basis of the predicted amount of code supplied from the code amount prediction unit 39. The code amount controlling unit 32 supplies to the mode decision unit 33 the image data for which the target amount of code has been set.

The mode decision unit 33 determines a macroblock (MB) mode for the image data supplied from the code amount controlling unit 32 and supplies to the intra prediction unit 34 the image data for which the MB mode has been determined.

The intra prediction unit 34 generates a predicted image by performing intra prediction on the basis of a reference image supplied from the inverse orthogonal transformation unit 38 and calculates the difference between the predicted image thus generated and the image data supplied from the mode decision unit 33. The intra prediction unit 34 supplies the difference information (residual image) obtained by the calculation to the orthogonal transformation unit 35.

The orthogonal transformation unit 35 applies orthogonal transformation such as discrete cosine transform or Karhunen-Loeve transform to the difference information supplied from the intra prediction unit 34 and supplies the resultant transform coefficient to the quantization unit 36.

The quantization unit 36 quantizes the transform coefficient supplied from the orthogonal transformation unit 35 and supplies the quantized transform coefficient to the dequantization unit 37, code amount prediction unit 39, and encoding unit 40.

The dequantization unit 37 dequantizes the quantized transform coefficient supplied from the quantization unit 36 and supplies the dequantized transform coefficient to the inverse orthogonal transformation unit 38. The inverse orthogonal transformation unit 38 applies inverse orthogonal transformation to the transform coefficient supplied from the dequantization unit 37 and supplies the inverse orthogonal transformation result as a reference image to the intra prediction unit 34.

The code amount prediction unit 39 predicts the amount of code of the corresponding image data on the basis of the quantized transform coefficient that is supplied from the quantization unit 36 as the result of the first pass of encoding process in the 2-pass encoding scheme. The code amount prediction unit 39 supplies the predicted amount of code to the code amount controlling unit 32.

The encoding unit 40 encodes in the H.264/AVC scheme the quantized transform coefficient that is supplied from the quantization unit 36 as the result of the second pass of encoding process in the 2-pass encoding scheme and outputs the compressed image thus obtained to a recording unit and/or transmission line (both not shown), for example, in a subsequent stage. The encoding unit 40 performs CABAC (context-adaptive binary arithmetic coding)-based encoding.

### [Structure of Encoding Unit]

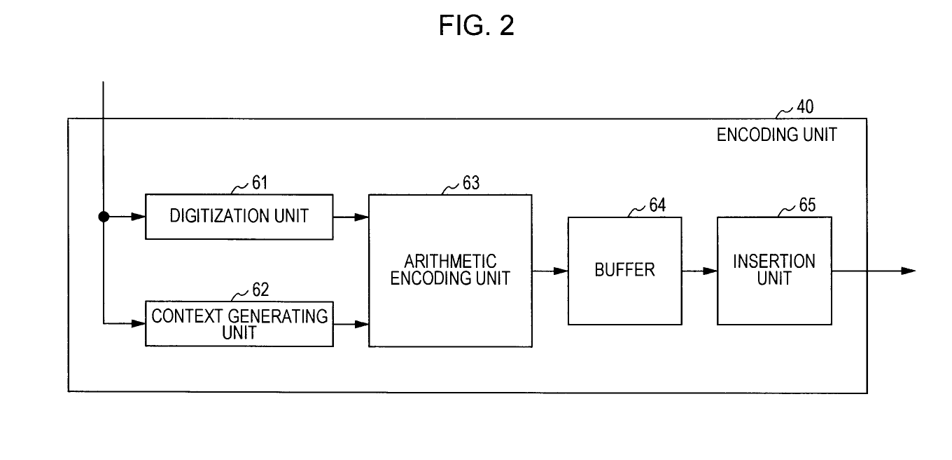

The structure of the encoding unit 40 in the encoder 11 will now be described with reference to FIG. 2.

The encoding unit 40 in FIG. 2 includes a digitization unit 61, context generating unit 62, arithmetic encoding unit 63, buffer 64, and insertion unit 65.

The digitization unit 61 digitizes the syntax elements (SE) supplied as the quantized transform coefficients from the quantization unit 36 into binary strings and supplies each bit of the strings as the symbol to the arithmetic encoding unit 63.

The context generating unit 62 supplies to the arithmetic encoding unit 63 a context index of the SE supplied from the quantization unit 36, in which a symbol with high probability of appearance and a table about the probability of appearance of the symbols are indexed.

The arithmetic encoding unit 63 performs arithmetic encoding on the basis of the symbol supplied from the digitization unit 61 and the context index supplied from the context generating unit 62 and supplies the resultant bit stream of which output bits have been determined to the buffer 64 for accumulation.

The insertion unit 65 monitors the bit stream accumulated in the buffer 64 and reads with predetermined timing the stored bit stream. The insertion unit 65 inserts one byte of predetermined data into the predetermined byte sequences so that the bit streams are read as byte streams conforming to the H.264/AVC standard (NAL (network abstraction layer) structure), and outputs the resultant bit streams to a recording device and/or transmission line (both not shown).

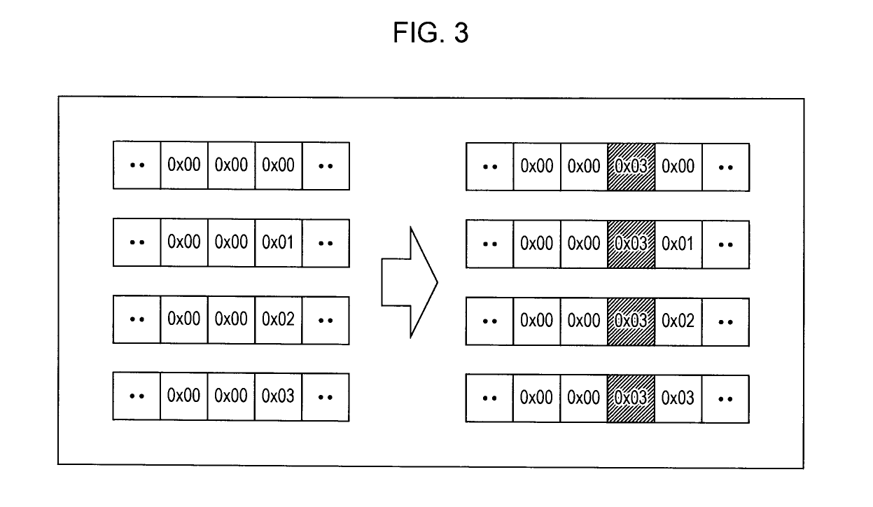

More specifically, in the H.264/AVC scheme, there is a rule that, if RBSPs (raw byte sequence payloads) encoded from video signals contain a predetermined data sequence (0x00, 0x00, 0xXX (XX being 00, 01, 02, or 03)) as shown in the left area in FIG. 3, the RBSPs are converted to EBSPs (encapsulated byte sequence payloads) by inserting one byte of data (0x03) called the EPB (emulation prevention byte) shown by hatching in FIG. 3 between 0x00, 0x00 and 0xXX as shown in the right area in FIG. 3 to prevent false appearance of the start code (0x00, 0x00, 0x01) defined in the H.264/AVC scheme. In this way, EPBs are inserted into predetermined data sequences in the encoded video signals in the H.264/AVC scheme.

### [Description of Arithmetic Encoding Process]

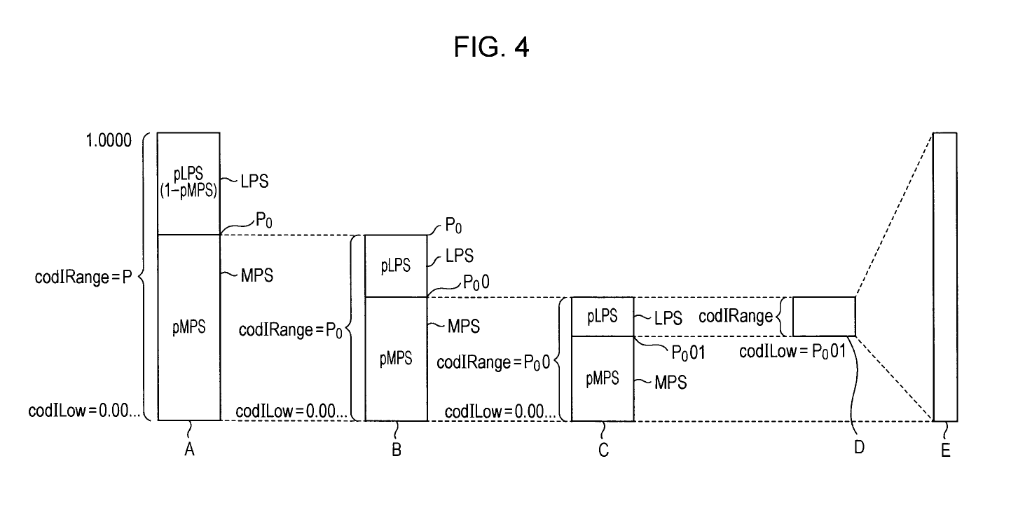

The arithmetic encoding process performed by the arithmetic encoding unit 63 in FIG. 3 will now be described with reference to FIG. 4.

In the arithmetic encoding process, for example, the data string to be encoded, such as symbols and binary (0 and 1) sequences are projected into the range [0,1] according to their probabilities of appearance and the probability spaces on the number line are expressed in binary form with the numbers in the spaces and encoded.

For example, as shown in FIG. 4, the range from 0.00 . . . to less than 1.00 . . . is divided on the basis of the probabilities of appearance of individual data in the data string to be encoded and a recursive process is performed to select a divided range on the basis of individual data and the data indicating the range corresponding to the data string to be encoded is encoded. For ease of description, the data to be encoded is assumed hereinafter to be binary.

First, specifically as shown in state A in FIG. 4, the predetermined range P is divided according to the probabilities of appearance pMPS and pLPS of the data with high probabilities of appearance MPS (most probable symbol) and the data with low probabilities of appearance LPS (least probable symbol), respectively, of the data string to be encoded. Here, the width (probability width) of the current range is assumed to be codIRange and the lower limit of the current range is assumed to be codILow. The probability of appearance pMPS is expressed as 1−pLPS.

In this way, in the initial state, as shown in state A in FIG. 4, the width codIRange and the lower limit codILow have values P and 0.00 . . . , respectively.

If the first data in the data string to be encoded is MPS, the range P is divided into ranges according to the probabilities of appearance pMPS and pLPS as shown in state A in FIG. 4, and the range corresponding to MPS is selected from the ranges as shown in state B in FIG. 4. Here, the width codIRange and the lower limit codILow have values P₀ (=pMPS) and 0.00 . . . , respectively.

Next, if the second data in the data string to be encoded is MPS, the range is divided into ranges according to the probabilities of appearance pMPS and pLPS as shown in state B in FIG. 4, and the range corresponding to MPS is selected from the ranges as shown in state C in FIG. 4. Here, the width codIRange and the lower limit codILow have values P₀0 (=P₀×pMPS) and 0.00 . . . , respectively.

Then, if the third data in the data string to be encoded is LPS, the range is divided into ranges according to the probabilities of appearance pMPS and pLPS as shown in state C in FIG. 4, and the range corresponding to LPS is selected from the ranges as shown in state D in FIG. 4. Here, the width codIRange and the lower limit codILow have values P₀0×pLPS and P₀01 (codILow+pMPS), respectively.

This means that, in the encoding process described above, for LPS, the value of lower limit codILow is updated by adding pMPS to the value of lower limit codILow.

In this way, in the arithmetic encoding process, as the bit length of the data string to be encoded is increased, the width codIRange is reduced and the number of data bits expressing the width codIRange is increased. Since the defined bits are output after the encoding process, the memory capacity is reduced.

In addition, in the arithmetic encoding process, to retain the accuracy of calculation, a renormalization process (Renormalize) takes place to make the width codIRange greater than a predetermined value as shown in state E in FIG. 4. In the renormalization process, for example, the value of width codIRange is doubled so as to become greater than the predetermined value.

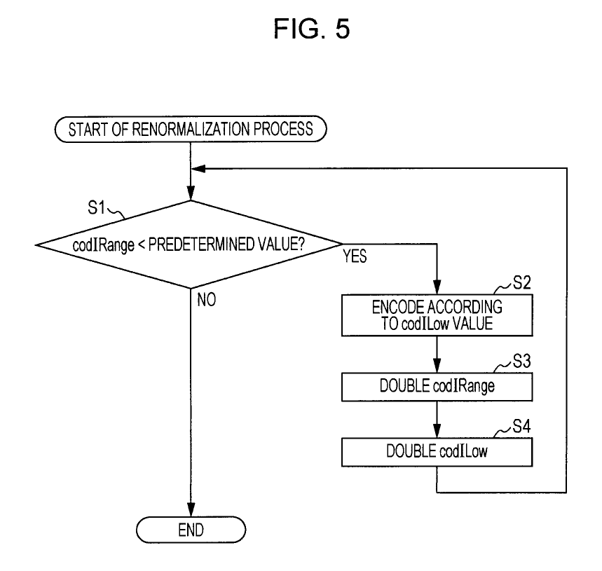

FIG. 5 is a flowchart illustrating a renormalization process in a typical encoding process.

For example, a renormalization process as shown in FIG. 5 takes place each time the data string to be encoded is encoded bit by bit as described above. More specifically, first in step S1, it is determined whether or not the width codIRange is smaller than the predetermined value that has been preset; if smaller, the process proceeds to step S2 in which the sign corresponding to the most significant bit of the value of lower limit codILow is output. Subsequently, in steps S3 and S4, a left shift operation is applied to the values of width codIRange and lower limit codILow to double these values, and then the process returns to step S1. The operations in steps S1 to S4 are repeated until the value of width codIRange reaches or exceeds the predetermined value.

On the other hand, if the value of width codIRange is equal to or greater than the predetermined value in step S1, the renormalization process ends.

As described above, in the renormalization process, it is determined bit by bit whether or not the width codIRange is equal to or greater than the predetermined value.

### [Structure of Code Amount Prediction Unit]

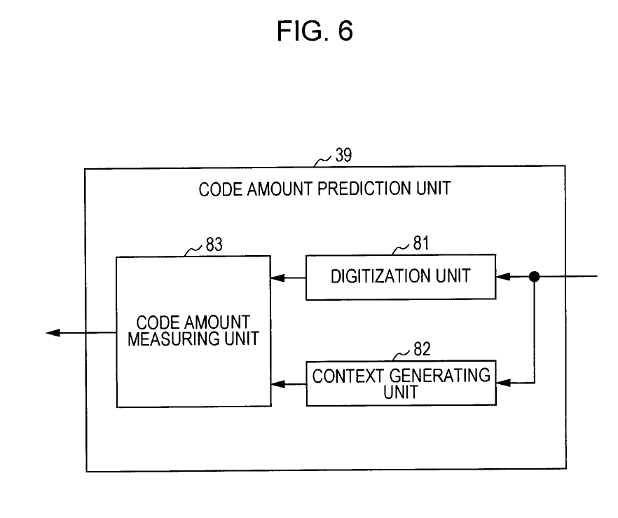

The structure of the code amount prediction unit 39 in the encoder 11 will now be described with reference to FIG. 6.

The code amount prediction unit 39 in FIG. 6 includes a digitization unit 81, context generating unit 82, and code amount measuring unit 83. The functions of the digitization unit 81 and context generating unit 82 are similar to those of the digitization unit 61 and context generating unit 62 in the encoding unit 40 described with reference to FIG. 2, so description thereof is omitted. The code amount prediction unit 39 does not have the buffer 64 and insertion unit 65 provided in the encoding unit 40.

In the arithmetic encoding process performed on the basis of the symbols supplied from the digitization unit 81 and the context index supplied from the context generating unit 82 as described above, the code amount measuring unit 83 measures the predicted amount of code of the data to be encoded, on the basis of the number of times of renormalization processing performed each time the data string to be encoded is encoded bit by bit. As described above, in the arithmetic encoding process, since the renormalization process is performed each time one bit of the encoded data is output, the number of times of renormalization processing represents the number of output bits of the encoded data, i.e., the predicted amount of code.

The code amount measuring unit 83 does not output the encoded data, but supplies the predicted amount of code that has been measured, to the code amount controlling unit 32.

### [Description of Encoding Process]

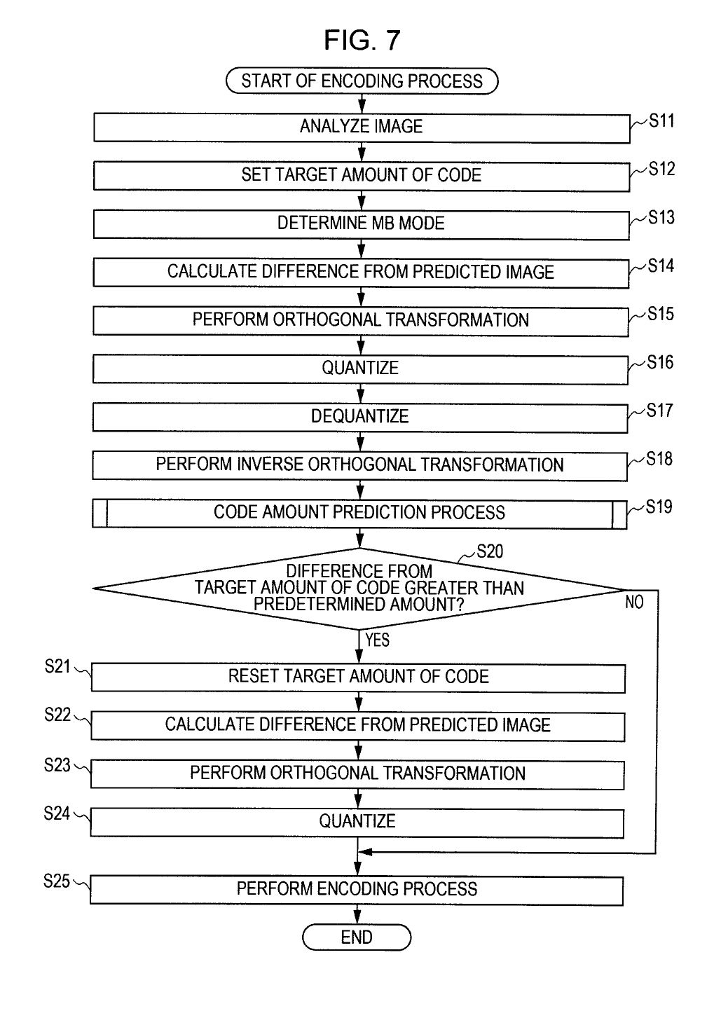

The encoding process performed by the encoder 11 will now be described with reference to the flowchart in FIG. 7. As described above, the encoder 11 performs encoding in the 2-pass encoding scheme.

In step S11, the image analyzing unit 31 converts each of the sequentially input frame images of an image into image data including luminance signals and corresponding chrominance signals and supplies the image data to the code amount controlling unit 32.

In step S12, for each image data supplied from the image analyzing unit 31, the code amount controlling unit 32 sets as the target amount of code (quantization value) the amount of code that becomes optimum when the image data is encoded in a predetermined quantization step. The code amount controlling unit 32 supplies the image data for which the target amount of code has been set to the mode decision unit 33.

In step S13, the mode decision unit 33 determines a macroblock (MB) mode for the image data supplied from the code amount controlling unit 32 and supplies the image data for which the MB mode has been determined to the intra prediction unit 34.

In step S14, the intra prediction unit 34 generates a predicted image by performing an intra prediction process on the basis of the reference image supplied from the inverse orthogonal transformation unit 38 and calculates the difference between the predicted image thus generated and the image data supplied from the mode decision unit 33. The intra prediction unit 34 supplies the difference information (residual image) obtained by the calculation to the orthogonal transformation unit 35.

In step S15, the orthogonal transformation unit 35 applies orthogonal transformation such as discrete cosine transform or Karhunen-Loeve transform to the difference information supplied from the intra prediction unit 34 and supplies its transform coefficient to the quantization unit 36.

In step S16, the quantization unit 36 quantizes the transform coefficient supplied from the orthogonal transformation unit 35 and supplies the quantized transform coefficient to the dequantization unit 37, code amount prediction unit 39, and encoding unit 40.

In step S17, the dequantization unit 37 dequantizes the quantized transform coefficient supplied from the quantization unit 36 and supplies the dequantized transform coefficient to the inverse orthogonal transformation unit 38.

In step S18, the inverse orthogonal transformation unit 38 applies inverse orthogonal transformation to the transform coefficient supplied from the dequantization unit 37 and supplies the inverse orthogonal transformation result as a reference image to the intra prediction unit 34.

The processing steps described above correspond to the first pass of encoding process in the 2-pass encoding scheme.

In step S18, the code amount prediction unit 39 performs a code amount prediction process in which the amount of code of the corresponding image data is predicted on the basis of the quantized transform coefficient supplied from the quantization unit 36 as the result of the first pass of encoding process in the 2-pass encoding scheme. More specifically, the code amount prediction unit 39 performs a code amount prediction process in which the predicted amount of code of the data to be encoded is measured on the basis of the number of times of renormalization processing in the CABAC-based encoding process (arithmetic encoding process).

The CABAC-based encoding processes are classified into three types of encoding processes according to the type of the SE (syntax element) provided. More specifically, in the CABAC-based encoding process, any one of the processes EncodeDecision, EncodeBypass, and EncodeTerminate is performed.

EncodeBypass is performed when SE is a positive or negative sign, for example, of the transform coefficient, while EncodeTerminate is performed when SE indicates the end of slice, for example. EncodeDecision is performed when SE is other than those described above.

In the code amount prediction process by the code amount prediction unit 39, a code amount prediction process corresponding to one of the three types of encoding processes is performed depending on the type of SE.

### [Code Amount Prediction Process 1]

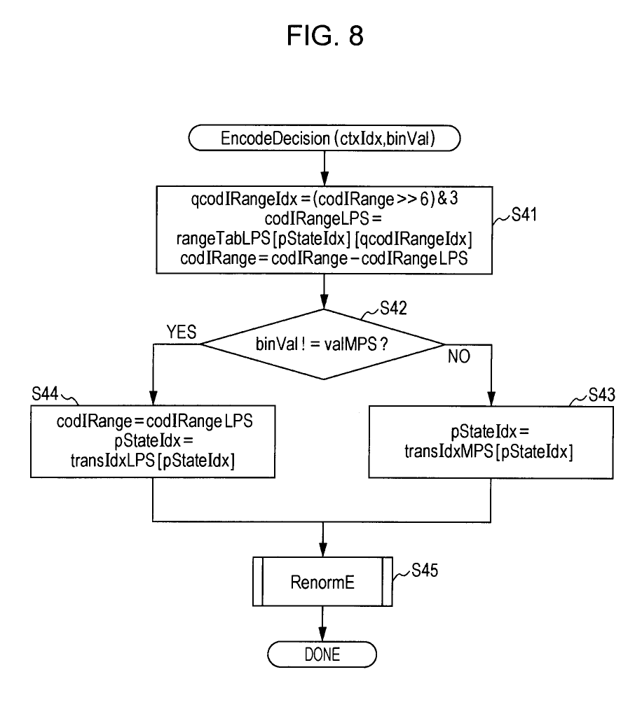

First, the code amount prediction process corresponding to EncodeDecision will be described with reference to the flowchart in FIG. 8. The code amount prediction process in FIG. 8 starts when the code amount measuring unit 83 receives the symbol value binVal of the symbol (input symbol) from the digitization unit 81 and the context index ctxIdx from the context generating unit 82.

In step S41, the code amount measuring unit 83 shifts the value of probability width codIRange to the right by six bits, takes the value with its lower two bits excluded as the qCodIRangeIdx, determines the probability width codIRangeLPS for LPS by using the table value rangeTabLPS defined in H.264/AVC, and changes the probability width codIRange to the probability width for MPS.

In step S42, the code amount measuring unit 83 determines whether or not the symbol value binVal of the input symbol is unequal to the valMPS indicating the MPS value. If the symbol value binVal is determined to be not unequal to valMPS, i.e., when the input symbol bin is MPS, the process proceeds to step S43, in which the code amount measuring unit 83 updates pStateIdx by causing state transition by the defined table value transIdxMPS. A greater value of pStateIdx, which is the table number of a table having the probability of appearance of MPS, corresponds to a higher probability of appearance of MPS.

On the other hand, if the symbol value binVal is determined to be unequal to valMPS in step S42, i.e., when the input symbol bin is LPS, the process proceeds to step S44.

In step S44, the code amount measuring unit 83 substitutes the probability width codIRangeLPS of LPS into the probability width codIRange and updates pStateIdx by causing state transition by the defined table value transIdxLPS.

After step S43 or S44, the process proceeds to step S45, in which the code amount measuring unit 83 performs renormalization processing (RenormE).

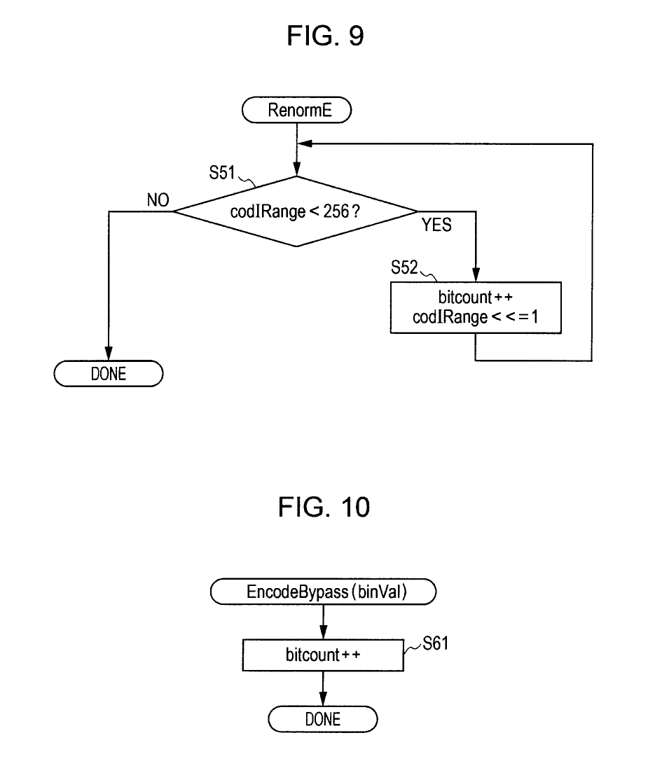

The renormalization processing (RenormE) will now be described with reference to FIG. 9.

In step S51, the code amount measuring unit 83 determines whether or not the probability width codIRange is smaller than the predetermined value (256) that has been preset; if smaller than the predetermined value, the process proceeds to step S52.

In step S52, the code amount measuring unit 83 increments by one the variable bitcount that counts the amount of code of the data to be encoded that is output in the arithmetic encoding process, and shifts by one bit the value of probability width codIRange to the left. Then, the process returns to step S51. The process steps S51 and S52 are thus repeated until the probability width codIRange is determined to be equal to or greater than the predetermined value that has been preset in step S51.

When it is determined in step S51 that the probability width codIRange is not smaller than the predetermined value that has been preset, the process returns to step S45 in the flowchart in FIG. 8 and then to step S19 in the flowchart in FIG. 7.

### [Code Amount Prediction Process 2]

Next, the code amount prediction process corresponding to EncodeBypass will be described with reference to the flowchart in FIG. 10. EncodeBypass is defined as a process including the so-called renormalization processing.

In step S61, the code amount measuring unit 83 increments by one the variable bitcount that counts the amount of code of the data to be encoded that is output in the arithmetic encoding process. Then, the process returns to step S19 in the flowchart in FIG. 7.

### [Code Amount Prediction Process 3]

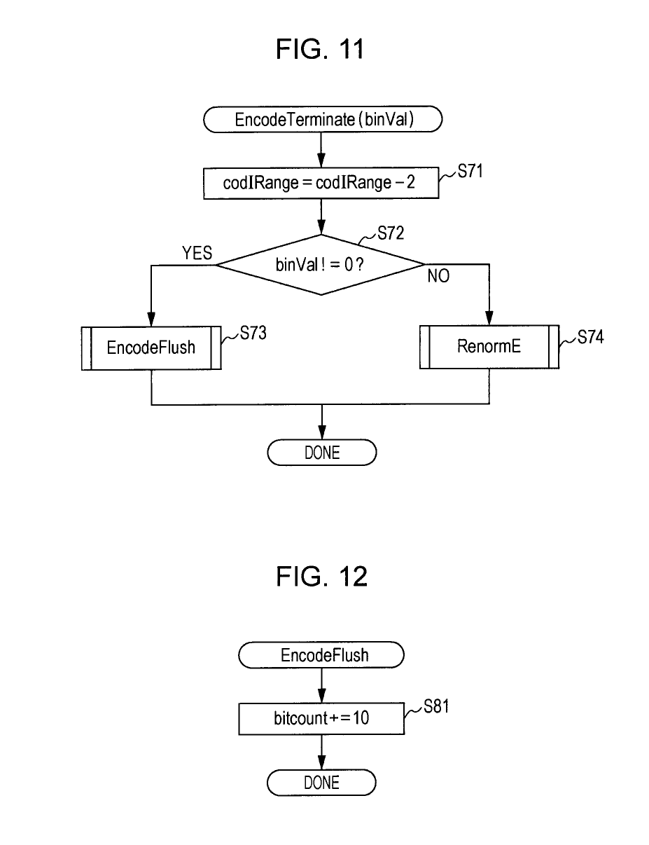

The code amount prediction process corresponding to EncodeTerminate will now be described with reference to the flowchart in FIG. 11.

In step S71, the code amount measuring unit 83 updates the value of probability width codIRange by subtracting two therefrom.

In step S72, the code amount measuring unit 83 determines whether or not the symbol value binVal of the input symbol is zero. If the symbol value binVal is determined to be not zero, i.e., when it is one, the process proceeds to step S73 in which EncodeFlush is executed.

EncodeFlush will now be described with reference to FIG. 12. EncodeFlush is defined as a process including the so-called renormalization processing.

In step S81, the code amount measuring unit 83 adds ten to the variable bitcount that counts the amount of code of the data to be encoded that is output in the arithmetic encoding process. Then, the process returns to step S73 in the flowchart in FIG. 11.

On the other hand, if the input symbol value binVal is determined to be zero in step S72, the process proceeds to step S74 in which the code amount measuring unit 83 performs the renormalization processing (RenormE) described above.

After step S73 or S74, the process returns to step S19 in the flowchart in FIG. 7.

In this way, in the code amount prediction process, the number of times of renormalization processing that is performed each time the encoding process is performed bit by bit in the arithmetic encoding process is counted as the variable bitcount without outputting the encoded data (bit stream) as in an actual arithmetic encoding process. More specifically, the variable bitcount is measured as the amount of code of the data to be encoded that has been obtained in the first pass of encoding process in the 2-pass encoding scheme and its value is supplied as the predicted amount of code to the code amount controlling unit 32. Then, the process proceeds to step S20.

In step S20, the code amount controlling unit 32 determines whether or not the difference between the predicted amount of code supplied from the code amount prediction unit 39 and the target amount of code that has been set is greater than a predetermined amount.

If it is determined in step S20 that the difference between the predicted amount of code and the target amount of code is greater than the predetermined amount, the process proceeds to step S21 in which the code amount controlling unit 32 resets the predicted amount of code supplied from the code amount prediction unit 39 as the target amount of code. The code amount controlling unit 32 supplies the image data of which the target amount of code has been reset to the intra prediction unit 34 via the mode decision unit 33. Here, the mode decision unit 33 does not determine the MB mode.

Subsequently, the second pass of encoding process in the 2-pass encoding scheme is performed. More specifically, in steps S22 to S24, the difference from the predicted image is calculated, orthogonal transformation is applied, and the transform coefficient is quantized.

In step S25, the encoding unit 40 applies the CABAC-based arithmetic encoding process described above to the quantized transform coefficient supplied from the quantization unit 36 as the result of the second pass of encoding process in the 2-pass encoding scheme and outputs the resultant compressed image to the recording device and/or transmission line (both not shown), for example, in a subsequent stage.

On the other hand, if the difference from the target amount of code is determined to be not greater than the predetermined amount in step S20, steps S21 to S24 are skipped, and in step S25, the encoding unit 40 applies the CABAC-based arithmetic encoding process described above to the quantized transform coefficient that is supplied from the quantization unit 36 as the result of the first pass of encoding process in the 2-pass encoding scheme.

With the above processing steps, in the code amount prediction process, the amount of code that is generated in actual encoding in the CABAC-based encoding scheme can be measured, without actually outputting the encoded data (bit stream), with an accuracy nearly equal to the amount of code that is generated in the actual encoding. Since the bit stream is not actually output, the predicted amount of code can be measured without writing the stream for storage, performing the calculation for determining the output bits in CABAC, or inserting an EPB, and faster prediction of the code amount is thereby enabled.

In the above description, the code amount prediction process according to an embodiment of the present disclosure is applied to the encoding process in which encoding is performed in a plurality of passes to identify the optimum encoding parameter (target amount of code). Alternatively, if a number of encoders corresponding to the total number of encoding parameters are prepared and used for the encoding processes performed in parallel, the stream is not written for storage, so a buffer such as the one provided in the encoding unit 40 is not necessary in the code amount prediction unit and the mounting cost can be reduced.

### [Exemplary Structure of Decoder]

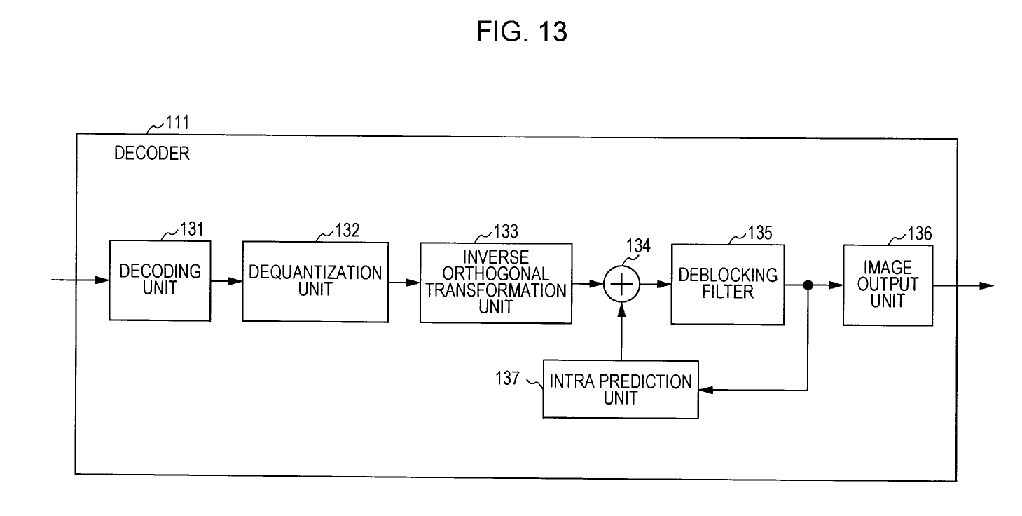

FIG. 13 shows an exemplary structure of a decoder that decodes the data encoded by the encoder 11 described above.

The data encoded by the encoder 11 is transmitted over a predetermined transmission line or the like to the decoder 111 and decoded.

The decoder 111 shown in FIG. 13 includes a decoding unit 131, dequantization unit 132, inverse orthogonal transformation unit 133, calculation unit 134, deblocking filter 135, and image output unit 136.

The decoding unit 131 accumulates the incoming encoded data, decodes with predetermined timing the data in the scheme corresponding to the encoding scheme of the encoding unit 40 in FIG. 1, and supplies as the syntax element (SE) the quantized transform coefficient thus obtained to the dequantization unit 132.

The dequantization unit 132 dequantizes the quantized transform coefficient supplied from the decoding unit 131 in the scheme corresponding to the quantization scheme of the quantization unit 36 in FIG. 1 and supplies the dequantized transform coefficient to the inverse orthogonal transformation unit 133.

The inverse orthogonal transformation unit 133 applies inverse orthogonal transformation to the transform coefficient supplied from the dequantization unit 132 in the scheme corresponding to the orthogonal transformation scheme of the orthogonal transformation unit 35 in FIG. 1 to obtain the decoded difference information (residual image) corresponding to the difference information that has not been subjected to orthogonal transformation in the encoder 11, and supplies the obtained difference information to the calculation unit 134.

The decoded difference information obtained after the inverse orthogonal transformation is supplied to the calculation unit 134. The predicted image is also supplied to the calculation unit 134 from the intra prediction unit 137.

The calculation unit 134 adds the decoded difference information supplied from the inverse orthogonal transformation unit 133 to the predicted image supplied from the intra prediction unit 137, to obtain the decoded image data that corresponds to the image data from which the predicted image has not been subtracted by the intra prediction unit 34 in the encoder 11. The calculation unit 134 supplies the decoded image data to the deblocking filter 135.

The deblocking filter 135 eliminates blocking artifacts in the decoded image data supplied from the calculation unit 134 and supplies the resultant image data to the image output unit 136.

The image output unit 136 applies D/A conversion to the decoded image data supplied from the deblocking filter 135 and outputs the resultant image data to a display (not shown) on which its image is displayed.

The output from the deblocking filter 135 is also supplied to the intra prediction unit 137.

The intra prediction unit 137 generates a predicted image from the decoded image data supplied from the deblocking filter 135 and supplies the predicted image thus generated to the calculation unit 134.

### [Decoding Process]

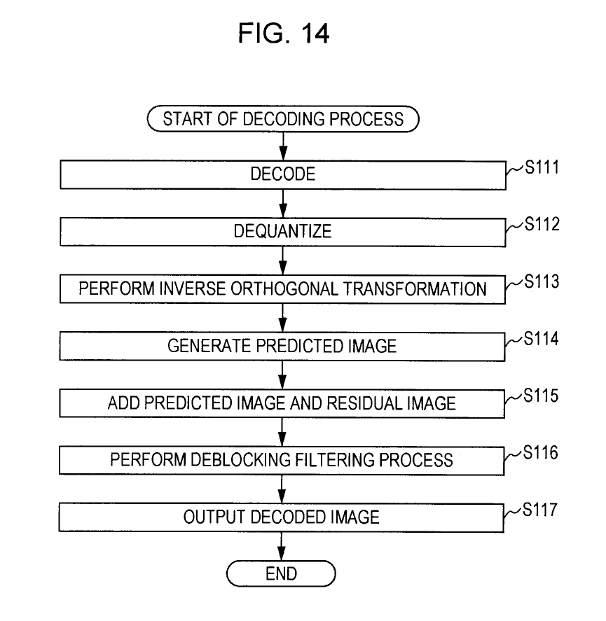

The decoding process by the decoder 111 in FIG. 13 will now be described with reference to FIG. 14.

When the decoding process is initiated, the decoding unit 131 decodes in step S111 with predetermined timing the encoded data that has been received and accumulated and supplies to the dequantization unit 132 the quantized transform coefficient that is obtained as the result of decoding.

In step S112, the dequantization unit 132 dequantizes the quantized transform coefficient decoded by the decoding unit 131, in the scheme corresponding to the quantization process by the quantization unit 36 in FIG. 1.

In step S113, the inverse orthogonal transformation unit 133 applies inverse orthogonal transformation to the transform coefficient dequantized by the dequantization unit 132 in the scheme corresponding to the orthogonal transformation process performed by the orthogonal transformation unit 35 in FIG. 1. With this, the difference information (residual image) corresponding to the input (output from the intra prediction unit 34) to the orthogonal transformation unit 35 in FIG. 1 is decoded.

In step S114, the intra prediction unit 137 generates a predicted image from the decoded image data supplied from the deblocking filter 135 and supplies the predicted image thus generated to the calculation unit 134.

In step S115, the calculation unit 134 adds the predicted image supplied from the intra prediction unit 137 to the difference information (residual image) supplied from the inverse orthogonal transformation unit 133. With this, decoding is performed to obtain the original image data.

In step S116, the deblocking filter 135 filters as appropriate the image data (decoded image data) obtained from the process in step S115. With this, blocking artifacts are eliminated as appropriate from the decoded image data.

In step S117, the image output unit 136 applies D/A conversion to the decoded image data. This decoded image data is output to a display (not shown) on which its image is displayed.

In this way, the data encoded by the encoder 11 is decoded.

The encoding process described above may be executed by hardware or software. When a sequence of processing steps are executed by software, the programs forming part of the software are installed from a program recording medium to a computer incorporated in dedicated hardware or to a general-purpose personal computer, for example, capable of performing various functions once various program are installed.

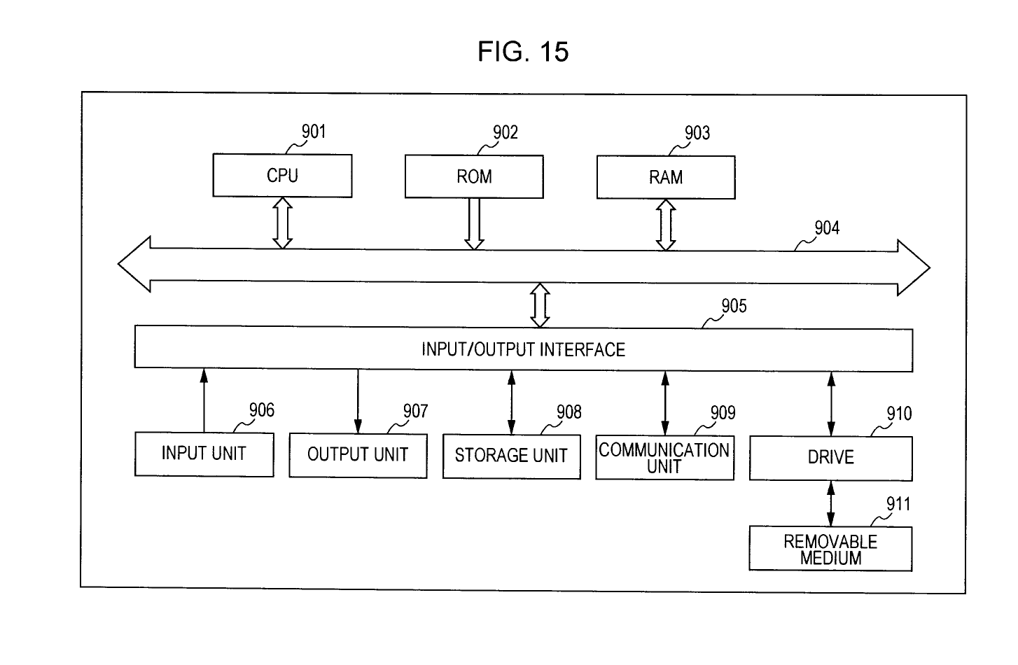

FIG. 15 is a block diagram showing an exemplary hardware structure of a computer that is caused by programs to perform the sequence of processing steps described above.

In this computer, CPU (central processing unit) 901, ROM (read only memory) 902, and RAM (random access memory) 903 are interconnected by a bus 904.

An input/output interface 905 is also connected to the bus 904. Connected to the input/output interface 905 are an input unit 906 including a keyboard, mouse, and microphone, an output unit 907 including a display and speaker, a storage unit 908 including a hard disk and nonvolatile memory, communication unit 909 including a network interface, and a drive 910 for driving a removable medium 911 such as a magnetic disk, optical disk, magneto-optical disk, semiconductor memory, or the like.

In a computer thus structured, CPU 901 loads the programs stored in the storage unit 908, for example, to RAM 903 via the input/output interface 905 and bus 904 to perform the sequence of processing steps described above.

The programs executed by the computer (CPU 901) are provided in the form of a removable medium 911 that is a packaged medium including a magnetic disk (including a flexible disk), optical disk (CD-ROM (compact disc-read only memory), DVD (digital versatile disc), etc.), magneto-optical disk, or semiconductor memory, etc., or via a wired or wireless transmission medium such as a local area network, Internet, or digital satellite broadcasting.

The programs can be installed into the storage unit 908 via the input/output interface 905 once the removable medium 911 is mounted in the drive 910. The programs can also be received by the communication unit 909 via a wired or wireless transmission medium and installed into the storage unit 908. Furthermore, the program can be preinstalled in ROM 902 or storage unit 908.

The programs executed by the computer may be programs for performing the processing steps in the time sequence described in this specification, or programs for performing the processing steps in parallel or at necessary times, such as when invoked.

Embodiments of the present disclosure are not limited to the embodiments described above, but various modifications may be made without departing from the spirit and scope of the present disclosure.

The present disclosure contains subject matter related to that disclosed in Japanese Priority Patent Application JP 2010-232559 filed in the Japan Patent Office on Oct. 15, 2010, the entire contents of which are hereby incorporated by reference.

What is claimed is:

1. An encoder including a code amount prediction unit predicting an amount of code of data to be encoded, the code amount prediction unit comprising:
a conversion unit converting an input syntax element to symbol data; and
a measurement unit measuring a predicted amount of code of the data to be encoded on the basis of the number of times of renormalization processing performed on each bit in an arithmetic encoding process applied to the symbol data.

2. The encoder according to claim 1, wherein the code amount prediction unit measures the predicted amount of code of the data to be encoded that is output by the arithmetic encoding process applied to the symbol data, without inserting an emulation prevention byte into the encoded data.

3. The encoder according to claim 2, wherein the code amount prediction unit measures the predicted amount of code of the data to be encoded that is output by the arithmetic encoding process applied to the symbol data, without accumulating the encoded data.

4. The encoder according to claim 1, wherein the arithmetic encoding is context-based adaptive binary arithmetic coding.

5. The encoder according to claim 4, wherein the arithmetic encoding is at least one of EncodeDecision, EncodeBypass, or EncodeTerminate of context-based adaptive binary arithmetic coding.

6. A code amount prediction method of an encoder including a code amount prediction unit predicting an amount of code of data to be encoded, the method comprising:
measuring the predicted amount of code of the data to be encoded on the basis of a number of times of renormalization processing performed on each bit in an arithmetic encoding process applied to symbol data converted from an input syntax element.

7. A program causing a computer to execute a code amount prediction process predicting an amount of code of data to be encoded, the process comprising:
measuring the predicted amount of code of the data to be encoded on the basis of a number of times of renormalization processing performed on each bit in an arithmetic encoding process applied to symbol data converted from an input syntax element.
